(19) United States
(12) Patent Application Publication
(10) Pub. No.: US 2007/0220713 A1
(43) Pub. Date: Sep. 27, 2007

(54) Method for Forming Zno Nano-Array and Zno Nanowall for Uv Laser On Silicon Substrate

(76) Inventors: Jin Ho Choy, Seoul (KR); Eue Soon Jang, Seoul (KR); Jung Hee Won, Seoul (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/595,686

(22) PCT Filed: Nov. 6, 2004
(86) PCT No.: PCT/KR04/02866

§ 371 Date: Dec. 27, 2006

(30) Foreign Application Priority Data
Nov. 6, 2003 (KR) 10-2003-0078244

(51) Int. Cl. B82B 3/00

(52) U.S. Cl. 23/305 R

(57) ABSTRACT

Provided are low-temperature formation methods of a perfectly oriented ZnO nanorod array and a new-type ZnO nanowall array having a new crystal growth rate, morphology, and orientation, from ZnO nanoparticles coated on a substrate. The method of forming the ZnO nanorod array includes synthesizing ZnO nanoparticles, coating on a substrate the ZnO nanoparticles serving both as a buffer layer and a seed layer, and growing the ZnO nanoparticles into crystals in a nutrient solution containing Zn nitrate, Zn acetate, or a derivative thereof, and hexamethylenetetramine. The method of forming the ZnO nanowall array includes synthesizing ZnO nanoparticles, coating on a substrate the ZnO nanoparticles serving both as a buffer layer and a seed layer, and growing the ZnO nanoparticles into crystals in a nutrient solution containing Zn acetate or its derivative and sodium citrate.

### TECHNICAL FIELD

The present invention relates to low-temperature formation methods of a perfectly oriented and grown ZnO nanorod array and a new type ZnO nanowall array having new crystal growth rate, morphology, and orientation, on a ZnO nanoparticle-coated substrate.

### BACKGROUND ART

Recently, there has been observed room-temperature UV laser emission in ZnO semiconductors. Therefore, much attention has been paid to ZnO semiconductors as promising substitutes for Group III-V nitride semiconductors that have been most widely used for UV-lasers and light-emitting diodes (LEDs). With respect to bulk ZnO, laser emission is observed only at an ultra-low temperature. However, as the size of ZnO is reduced to a nanometer level, room-temperature laser emission occurs. In this respect, numerous studies that have been made hitherto have been focused on enhancement of laser characteristics by size-reduction of ZnO.

Generally, in UV laser of ZnO, the [0001] polar planes play an important role both as reflecting mirrors and Fabry-Perot cavities. In this respect, the perfect orientation of the [0001] planes is a very important factor in laser characteristics of ZnO. With remarkable development in the area of science, such perfect orientation has been accomplished by molecular beam epitaxie (MBE) (J. Appl. Phys. Lett., 90, 4973, 2001), metal-organic chemical vapor deposition (MOCVD) (J. Mater. Res., 16, 1358, 2001), pulsed laser deposition (PLD) (J. Appl. Phys. Lett., 85, 7884, 1999), etc.

However, the above technologies generally require expensive equipment, high vacuum condition, high-temperature heat treatment, and the like. In particular, due to the difficulty of fabrication of vacuum chambers that can sustain high vacuum, it is impossible to form a large-area ZnO nanorod array. Furthermore, high-temperature heat treatment causes numerous oxygen defects. These oxygen defects are a major cause of broad green emission at about 510 nm and increase the laser threshold by interfering with UV emission.

Meanwhile, there has been recently reported a method of forming a high-quality ZnO nanorod array by a gold-catalyzed VPT (vapor-phase transport) process in which a bulk precursor is heat-treated around 1,000° C. [Science, 292, 1897, 2001]. Even though no expensive equipment is used for this method, there is a limitation on the type of a substrate that can be used for such a high-temperature heat treatment. That is, there have been mainly used substrates made of sapphire [Science, 292, 1897, 2001], GaN [J. Appl. Phys. Lett., 77, 537, 2000], ScAlMgO₄ [J. Cryst. Growth, 242, 283, 2002], LiNbO₃ [Thin Solid Films, 347, 238, 1999], etc. which have a small lattice mismatch with ZnO and a high thermal stability. However, these substrates are very costly, which renders industrial application difficult.

A Si-wafer is very inexpensive and the currently most advanced electronics technology has been applied thereto. However, there are disadvantages with Si-wafer are that a lattice mismatch with ZnO is very high (about 40%), and amorphous SiO₂ rapidly grows at a low temperature, relative to ZnO, thereby preventing the crystal growth of ZnO [Appl. Phys. Lett., 78, 1511, 2001]. To overcome these problems, many researchers have made efforts to synthesize ZnO nanorod arrays on Si-wafers using low-temperature hydrothermal synthesis.

However, there arise other problems such as random growth of ZnO on a Si-wafer from a nutrient solution in a hydrothermal synthesis condition, imperfect orientation of ZnO rods due to very large lattice mismatch between the Si-wafer and ZnO, and formation of ZnO microrods [Chem. Comm., 80, 2002., Adv. Mater., 14, 1221, 2002, and J. Phys. Chem. B, 105, 3350, 2001]. This ZnO array can produce laser only at a very low temperature as described above.

### BRIEF DESCRIPTION OF THE DRAWINGS

FIG. 1 is a High-Resolution Transmission Electron Microscopy (HR-TEM) image of ZnO nanoparticles prepared according to the present invention;

FIG. 2 is (a) a surface Scanning Electron microscopy (SEM) image, (b) a cross-section SEM image, and (c) a cross-section TEM image of a ZnO nanorod array formed on a Si-wafer;

FIG. 3 is a powder X-ray diffraction pattern of a ZnO nanorod array formed on a Si-wafer;

FIG. 4 is power-dependent photoluminescence (PL) spectra of a perfectly oriented ZnO nanorod array formed on a Si-wafer;

FIG. 5 is a PL spectrum of a ZnO nanorod array at 200 kW/cm²;

FIG. 6 is SEM images of (a) a surface and (b) a cross- of a ZnO nanowall array formed on a Si-wafer;

FIG. 7 is (a) an HR-TEM image of surface and (b) an HR-TEM image of cross-section of a ZnO nanowall array;

FIG. 8 is an illustration for the structure of ZnO nanowalls;

FIG. 9 is a powder X-ray diffraction pattern of a ZnO nanowall array;

FIG. 10 is power-dependent PL spectra of a ZnO nanowall array;

FIG. 11 is a PL spectrum of ZnO nanowalls at 15 kW/cm²;

FIG. 12 is an SEM image of a flower-like ZnO array formed on a Si-wafer by dip-coating in ZnO nanoparticle solution diluted more than about 20 times;

FIG. 13 is an SEM image of bulk ZnO particles with pineapple shape formed from a remaining solution after synthesis of a ZnO nanowall array; and

FIG. 14 is a SEM image of hexagonal plate-like ZnO nanoparticles formed by reacting ZnO nanoparticles with a nutrient solution without dip-coating on a Si-wafer.

### DETAILED DESCRIPTION OF THE INVENTION

### Technical Goal of the Invention

In view of the above problems of conventional formation methods of ZnO nanorod arrays, it is an object of the present invention to provide a method of forming a ZnO nanorod array perfectly oriented only at a very low temperature on a substrate using ZnO nanoparticles at a much lower temperature than in the conventional methods.

It is another object of the present invention to provide a method of forming a ZnO nanowall array having a new morphology different from previously known ZnO nanorod arrays using ZnO nanoparticles.

### Disclosure of the Invention

In order to solve the problems of previously known ZnO nanorod arrays, the present invention provides a method of forming a ZnO nanorod array, perfectly oriented only at a very low temperature, on a substrate at a low temperature.

More particularly, the present invention provides a method of forming a ZnO nanorod array, which includes: coating on a substrate ZnO nanoparticles serving both as a buffer layer and a seed layer and growing the ZnO nanoparticles into crystals in a nutrient solution containing hexamethylenetetramine and Zn nitrate, Zn acetate, or a derivative thereof.

In the method, a reaction temperature is in the range of 30-400° C., and preferably 90-100° C. The volume ratio of Zn nitrate, Zn acetate, or a derivative thereof to hexamethylenetetramine in the nutrient solution is 10:1 to 1:10, and preferably 1:1. The size and morphology of ZnO nanorods can be controlled by adjusting the concentration and composition ratio of the nutrient solution for the ZnO nanorod array. For example, a reaction time of 6 hours produces ZnO nanorods of about 1 μm in length and a reaction time of 24 hours produces ZnO nanorods of about 2 μm in length.

Problems of random orientation and bulk size of ZnO rods produced by a common hydrothermal synthesis are overcome by coating on a substrate uniform ZnO nanoparticles serving both as a buffer layer and a seed layer according to the present invention. That is, since the uniform ZnO nanoparticles have the same structure as ZnO to be grown, they not only can serve as an excellent buffer and seed layer for ZnO nanorods to be grown on the substrate but also can control the ZnO nanorods to a uniform, predetermined level size. The ZnO nanorod array thus formed exhibits similar laser characteristics to existing high-quality ZnO nanorod arrays synthesized at a high temperature or using expensive equipment.

The present invention also provides a method of forming a ZnO nanowall array having a new morphology different from a general ZnO nanorod array.

More particularly, the present invention provides a method of forming a ZnO nanowall array, which includes: coating on a substrate ZnO nanoparticles to serve both as a buffer layer and a seed layer and growing the ZnO nanoparticles into crystals in a nutrient solution containing sodium citrate and Zn acetate or its derivative.

In the method, a reaction temperature is in the range of 30-400° C., and preferably 90-100° C. The volume ratio of Zn acetate or its derivative to sodium citrate in the nutrient solution is 30:1 to 1:10, preferably 10:1. Like the ZnO nanorod array, the size and morphology of ZnO nanowalls can be controlled by adjusting the concentration and composition ratio of the nutrient solution for the ZnO nanowall array. For example, when the volume ratio of a Zn acetate solution to a sodium citrate solution is 20:1, the length and thickness of ZnO nanowalls are respectively increased up to 2 μm and 100 nm. That is, as the content of a sodium citrate solution decreases, the size of the ZnO nanowalls increases, and vice versa.

The ZnO nanowall array of the present invention has not been reported previously. The ZnO nanowall array of the present invention exhibits superior laser characteristics, relative to any previously known ZnO nano-arrays. Generally, the crystal growth rate of ZnO nanorods is in the order of V_{[0001]}>>V_{[01-10]}>V_{[000-1]}. Due to this, size reduction of the ZnO nanorods to increase laser characteristics results in the sizes of the [0001] planes get much more reduced than those of the [01-10] or [11-20] nonpolar planes [J. Cryst. Growth, 204, 186, 1999]. Therefore, incident light by external optical pumping is most scattered by the small-area [0001] planes. Furthermore, as in general high-quality ZnO nanorod arrays in which all [0001] planes are oriented along the direction of incident light, most light refracted by the [0001] planes is reflected outward without interruption.

Actually, the refractive index (2.4) of ZnO is much higher than that (1.00) of an ambient air, and thus, most incident light is directly reflected. Therefore, only a minute portion of incident light is transmitted and used for laser of ZnO. The lowest laser threshold in ZnO nanorods that have been developed hitherto is 40 kW/cm² which is obtained in a nanorod array synthesized by a gold-catalyzed VPT process as described in the literature [Science, 292, 1897, 2001]. To overcome these problems of common ZnO nanorod arrays, the [0001] planes must be large enough to allow incident light to pass through. Furthermore, the [0001] planes must face with each other to create optical traps so that reflected light dose not easily escape outward. In addition, the [0001] planes must be nano-sized to easily induce laser. A structure fulfilling these requirements is referred to as “nanowall” structure.

In the present invention, the crystal growth rate of the [0001] planes of the ZnO precursor nanoparticles is adjusted by low-temperature hydrothermal synthesis using citrate ions as follows: V_{[11-20}] or V_{[01-10]}>>V_{[0001]}≈V_{[000-1]}. The citrate ions are fixed to Zn ions of the [0001] polar planes by electrostatic force. Therefore, the [0001] planes are efficiently blocked from the nutrient solution, thereby decreasing a crystal growth rate [J. Am. Chem. Soc., 124, 12954, 2002].

Such low-temperature synthesis of the present invention enables use of a Si-wafer, unlike conventional techniques. Each ZnO nanowall has micro-sized [0001] planes and nano-sized [11-20] or [01-10] planes. The size of each plane can be controlled by adjusting the concentration of the citrate ions, reaction temperature and duration, and the concentration of the nutrient solution. The ZnO nanowalls thus formed create perfect optical traps by exceptional arrangement of the [0001] planes and have larger-area [0001] planes, relative to those of ZnO nanorods, thereby producing superior laser characteristics to currently available ZnO structures.

The ZnO nanoparticles used herein can be synthesized by a known method [for example, L. Spanhel and M. A. Anderson, J. Am. Chem. Soc. 113, 2826, 1991].

ZnO nanorod or nanowall array formation methods of the present invention is described in more detail. Organic substances and amorphous SiO₂ on a substrate (e.g., Si-wafer, sapphire (Al₂O₃), GaN, ScAlMgO₄, LiNbO₃, etc.) were removed by pretreatment. Then, ZnO nanoparticles are coated on the substrate, for example by dip-coating, spin-coating, or the like. The ZnO nanoparticles-coated substrate is placed in a Teflon autoclave and incubated with a nutrient solution at a low temperature, for example 90 to 100° C., preferably 95° C. A final product is washed with deionized water followed by water removal.

A low-temperature formation method of a ZnO nanowall array according to the present invention includes synthesizing ZnO nanoparticles, coating the ZnO nanoparticles on a substrate (e.g., Si-wafer, sapphire (Al₂O₃), GaN, ScAlMgO₄, LiNbO₃, etc.), and growing the ZnO nanoparticles into crystals in a nutrient solution containing citrate ions. At this time, a pretreatment of the substrate and a reaction condition are the same as in the ZnO nanorod array formation method.

### Effect of the Invention

A ZnO nanorod array according to the present invention exhibits almost equally excellent laser characteristics, as compared with general nanorod arrays formed using expensive equipment and processes. A ZnO nanowall array of the present invention exhibits superior laser characteristics to general nanorod arrays or nanodot arrays. Based on these UV laser characteristics, the laser devices that utilize the ZnO nanorod or nanowall array synthesized according to the present invention can be widely used in next generation high-density storage devices with data density over about three times higher than those of common DVDs or CDs using near-IR laser, medical lasers, industrial lasers, optical communications, holographics, and the like.

According to the present invention, a Si-wafer can be utilized without requiring a complicated apparatus. Therefore, fabrication of new devices having characteristics of the most advanced Si-optoelectronic devices and laser characteristics of ZnO is possible. Furthermore, it is known that the [0001] planes have excellent catalytic characteristics. Still furthermore, because of high-density large [0001] planes per unit area, the ZnO nanowall array of the present invention can be used as a catalyst for methanol or H₂O₂ production by decomposition of CO₂ or CO.

### BEST MODE FOR CARRYING OUT THE INVENTION

Hereinafter, the present invention will be described more specifically by Examples. However, the following examples are provided only for illustrations and thus the present invention is not limited to or by them.

### EXAMPLE 1

ZnO nanoparticles were synthesized by (1) synthesizing precursors from Zn acetate and ethanol (99.5%) followed by (2) hydrolysis with LiOH. In more detail, a solution of 0.01 M Zn acetate in 100 ml ethanol was placed in a 250 ml Erlenmeyer flask equipped with a reflux condenser. The reaction solution was refluxed and distilled at 78 to 85° C. for about 3 hours until the volume of the reaction solution reduced to 40 ml. In this step, a reaction time is very important. If the reaction time exceeds 3 hours, bulky nonuniform particles may be created, whereby the solution becomes turbid. On the other hand, if it is less than 3 hours, functions as precursors may be lowered. Final product of precursors must be clear and transparent. 40 ml of precursors solution obtained were diluted with 60 ml of 0.1 M LiOH ethanol solution. At this time, if the temperature of the reaction solution is increased, the crystal size of ZnO may increase, thereby producing a suspension. To solve this problem, the reaction solution was placed in an ice bath and treated with ultrasonication of 120 W, 35 kHz for about 2 minutes. ZnO nanoparticles thus prepared had a very uniform particle size of about 4 nm.

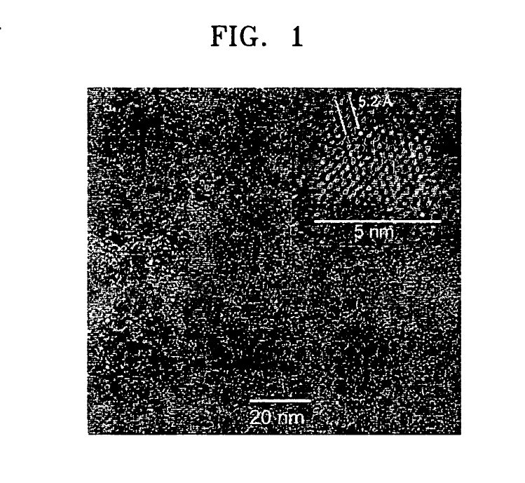

FIG. 1 is a High-Resolution Transmission Electron Microscopy (HR-TEM) image of the ZnO nanoparticles thus prepared. The distance between lattices was about 5.2 Å which was equal to the length of the c-axis in typical Wurtzite ZnO. Since these uniform ZnO nanoparticles are starting materials for nanowalls, they are very important in formation of uniform nanowalls.

### EXAMPLE 2

A Si-wafer to be used in the present invention was pretreated as follows. First, the Si-wafer was washed with acetone in an ultrasonic bath and then subjected to removal of organic substances using a piranha solution (a mixed solution composed of 30% H₂SO₄ and H₂O₂ in a 2:1 volume ratio) at room temperature for about 30 minutes. Amorphous SiO₂ on the Si-wafer was also removed using a 20% HF solution. The Si-wafer thus obtained was temporarily free from Si oxidation due to hydrogen coated on surface oxygen.

The Si-wafer after pretreatment was dip-coated with the ZnO nanoparticles synthesized in Example 1 at a rate of 4.21 cm/min and thermally treated at about 200° C. to immobilize the ZnO nanoparticles on the Si-wafer. However, a final product is not affected even when the thermal treatment is omitted.

### EXAMPLE 3

A nutrient solution for formation of a ZnO nanorod array was prepared by mixing a 0.1M Zn nitrate solution and a 0.1M hexamethylenetetramine (HMTA) solution in a volume ratio of 1 to 1 (pH=about 7.0). The ZnO nanoparticles-dip coated Si-wafer prepared in Example 2 was placed in a Teflon autoclave and then incubated with the nutrient solution at 95° C. for about 6 hours. However, a nanorod array can be formed even when the thermal treatment was performed for less than 1 hour. The final product was washed with deionized water (18.2 μΩ) followed by water removal at about 100° C.

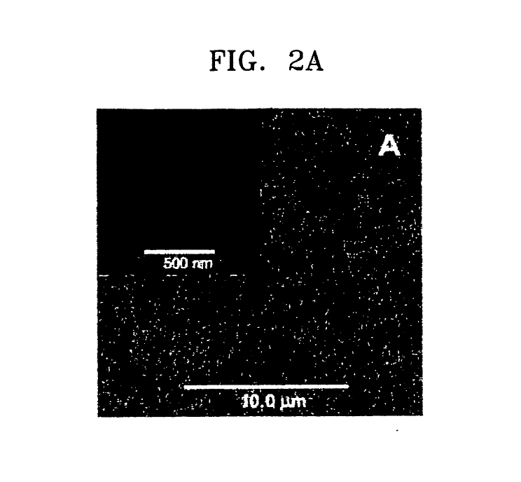

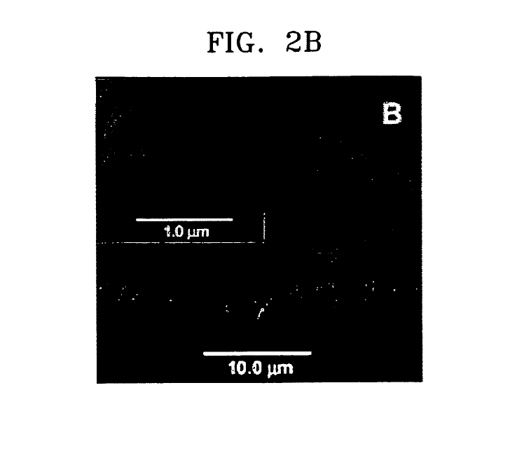

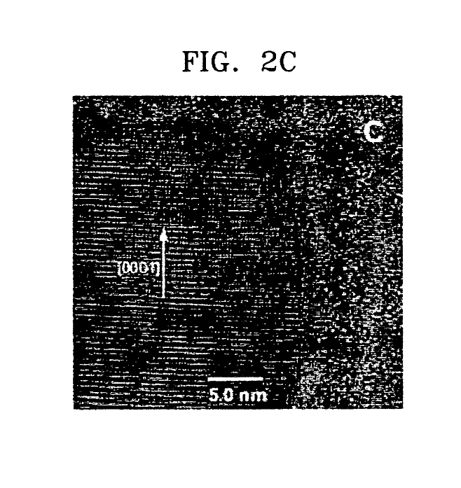

FIG. 2 is Scanning Electron Microscopy (SEM) images of surface(FIG. 2A), and a cross-section(FIG. 2B), and a TEM image of cross-section (FIG. 2C) of the ZnO nanorod array formed on the Si-wafer. As shown in FIG. 2, very dense ZnO nanorods of about 100 nm in diameter and about 1.5 μm in length were perfectly oriented on the Si-wafer.

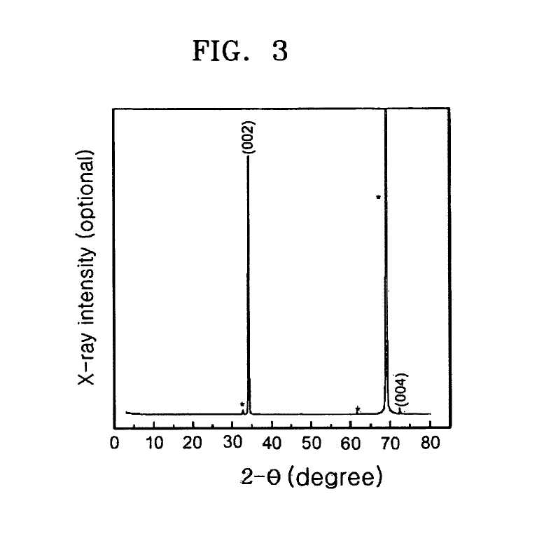

FIG. 3 is a powder X-ray diffraction pattern of the ZnO nanorod array formed on the Si-wafer. Referring to FIG. 3, due to the perfect orientation of the ZnO nanorods, only the (001) peaks were observed with no (hk0) peaks. This means that by the ZnO nanoparticles dip-coated on the Si-wafer, lattice mismatch with Si-wafer was efficiently reduced and the diameter and length of the ZnO nanorods were maintained uniform.

### EXAMPLE 4

To compare UV laser characteristics of the ZnO nanorod array perfectly oriented on the Si-wafer fabricated according to Example 3 with those of a common high-quality ZnO nanorod array, various photoluminescene (PL) experiments were performed.

For this, the ZnO nanorod arrays were optically pumped by various energies using a Q-switch YAG laser (Quanta, HYL-101) equipped with a 0.5-m spectrometer (Acton Research, Spectrapro-500) and an intensified charge-coupled device (CCD) (Princeton Instruments, ICCD576G) with gating resolution of 2 nanoseconds.

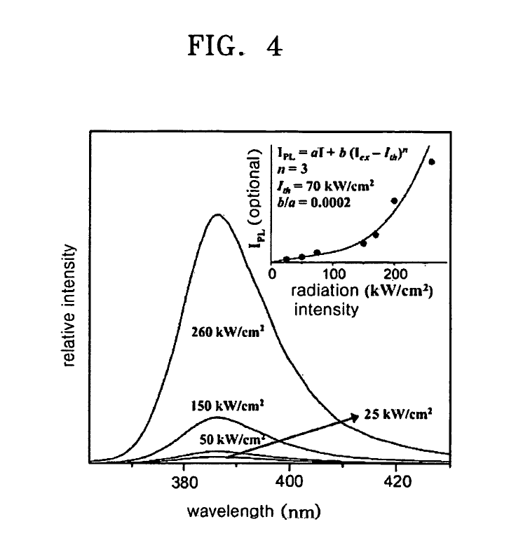

FIG. 4 is power-dependent PL spectra of the ZnO nanorod array perfectly oriented on the Si-wafer. Referring to FIG. 4, the UV laser threshold of the ZnO nanorod array of the present invention was 70 kW/cm² which was almost similar to the lowest threshold (40 kW/cm²) of a common ZnO nanorod array and was about 50% lower than the threshold (150 kW/cm²) of a common ZnO nanodot array.

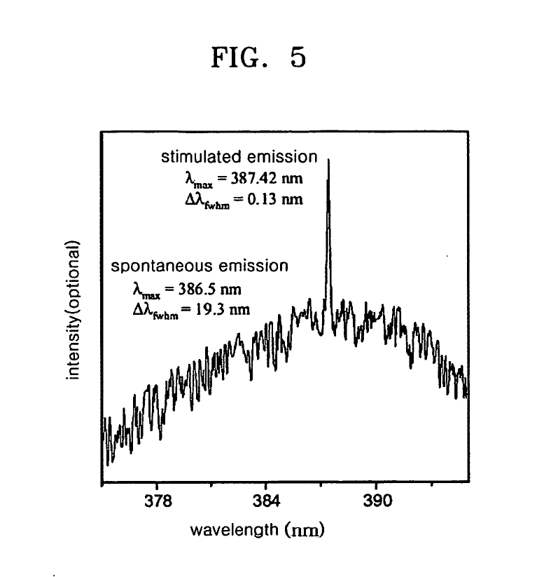

FIG. 5 is a PL spectrum of the ZnO nanorod array at 200 kW/cm². Referring to FIG. 5, it can be seen that very strong second-stimulated emission occurred at 200 kW/cm² by an electron-hole plasma (EHP) process. The linewidth of the second-stimulated emission was 0.13 nm which was about 4 times smaller than the emission linewidth (0.3 nm) of a common high-quality ZnO nanorod array at 100 kW/cm². The cavity length of the ZnO nanorod array calculated using the emission linewidth was 236 μm.

### EXAMPLE 5

A nutrient solution for formation of a ZnO nanowall array was prepared by mixing a 0.1M Zn acetate solution and a 0.28 mM sodium citrate solution in a volume ratio of 10 to 1. A ZnO nanoparticles-dip coated Si-wafer prepared in the same manner as in Example 2 was placed in a Teflon autoclave and then incubated with the nutrition solution at 95° C. for about 6 hours. However, nanowall arrays can also be formed even when the thermal treatment was performed for less than 1 hour. A final product was washed with deionized water (18.2 μΩ) followed by wafer removal at about 100° C.

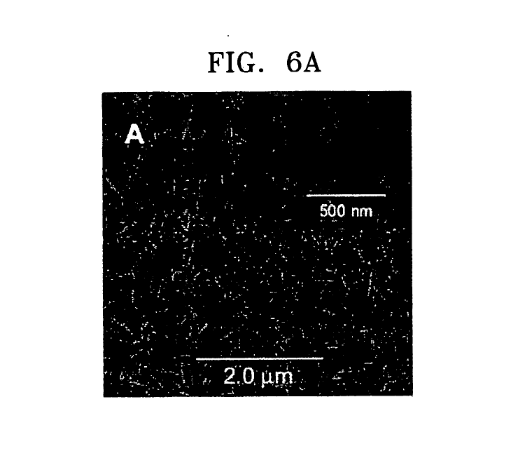

FIG. 6 is SEM images of surface (FIG. 6A) and cross-section(FIG. 6B) of the ZnO nanowall array formed on the Si-wafer. Referring to FIG. 6, the ZnO nanowall array exhibited a new morphology which had not been reported previously. That is, unlike common hexagonal rod-like ZnO, the ZnO nanowalls of the present invention had rectangular shape of about 500 nm in height and crystal planes of about 0.5 to 2 μm in width. The ZnO nanowalls were randomly oriented and faced with each other to efficiently create optical traps. In particular, the ZnO nanowalls had a large thickness ratio, i.e., an upper thickness of about 5 to 10 nm and a lower thickness of about 60 to 100 nm. That is, the vertical cross-sections of the ZnO nanowalls were triangle-like. Therefore, incident light, transmitted to the inner side of the ZnO nanowalls, can be accumulated on upper portions of the ZnO nanowalls.

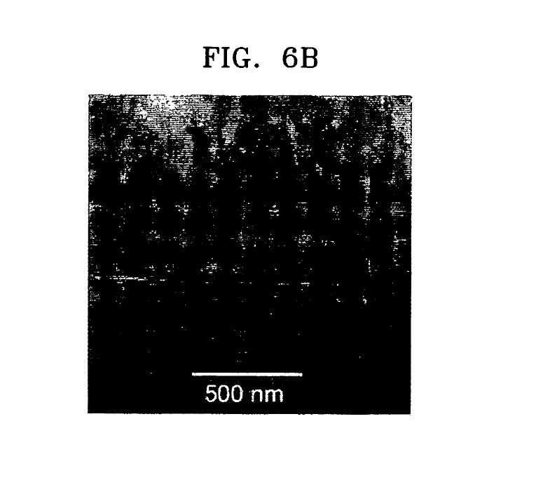

The crystalline planes of the ZnO nanowalls were observed by HR-TEM. FIG. 7 is a HR-TEM image of surface (FIG. 7A) and a cross-section(FIG. 7B) of the ZnO nanowall array. Referring to FIG. 7, microscale wide planes of the ZnO nanowalls corresponded to the [0001] planes of common ZnO and nanoscale thickness of the ZnO nanowalls corresponded to the [11-20] planes of common ZnO. This means that the crystal growth rate of the ZnO nanoparticles of the present invention is as follows: V_{[01-10]}>>V_{[0001]}≈V_{[000-1]}. That is, the growth of the [0001] planes was efficiently controlled by citrate ions, thereby inducing the growth of the ZnO nanowalls different from common hexagonal ZnO rods.

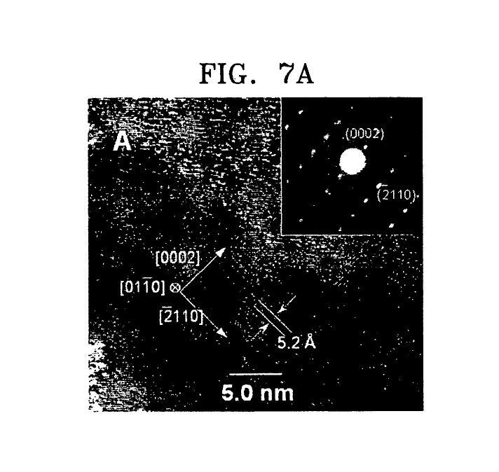

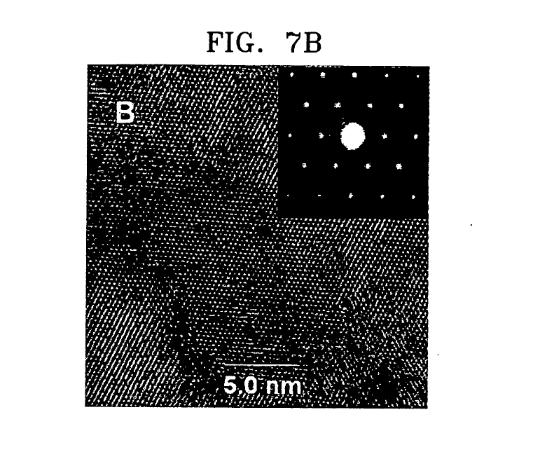

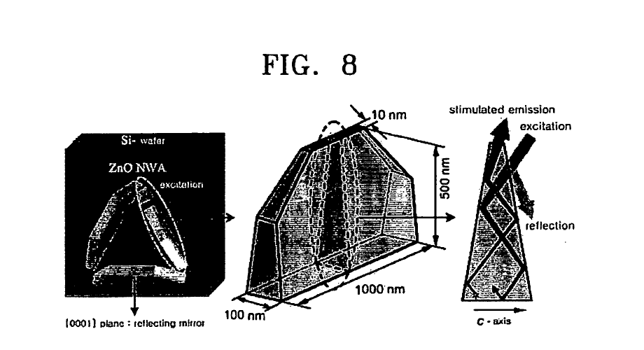

As described above, the [0001] planes play an important role in laser. Referring to FIG. 8, all the [0001] planes of the ZnO nanowall array were oriented perpendicularly to the Si-wafer and had a microscale wide area. Therefore, external light can efficiently pass through the [0001] planes. Further, the [0001] planes of the ZnO nanowall array were randomly oriented along the c-axis of crystal growth planes and created optical traps so that all incident light was reflected by the [0001] planes facing with each other and then absorbed in the ZnO media. Still furthermore, each ZnO nanowall had the [0001] planes with trapezoidal sections. Therefore, each ZnO nanowall can act as an efficient optical waveguide.

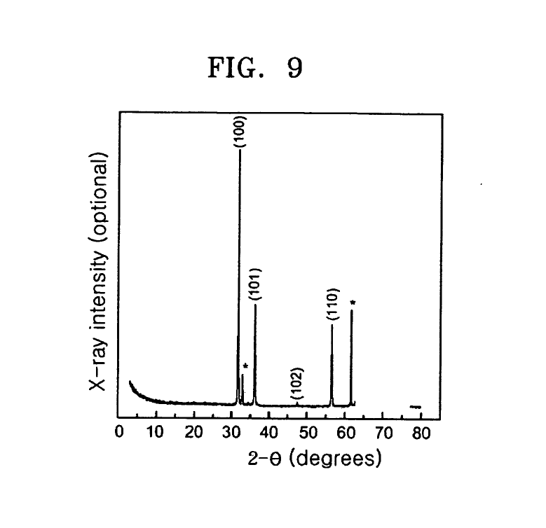

FIG. 9 is a powder X-ray diffraction pattern of the ZnO nanowall array. As described above, since all the [0001] planes were vertically aligned with respect to the Si-wafer, only the (hk0) peaks were observed in the X-ray diffraction pattern, which is in contrast to the result of FIG. 3 in which only the (00I) peaks were observed in the high-quality ZnO nanorod array formed in Example 3.

Due to such specific crystal growth rate, morphology, and orientation of the ZnO nanowall array formed according to the present invention, it is anticipated that the ZnO nanowall array exhibits remarkably enhanced UV laser characteristics, relative to common nanorod arrays.

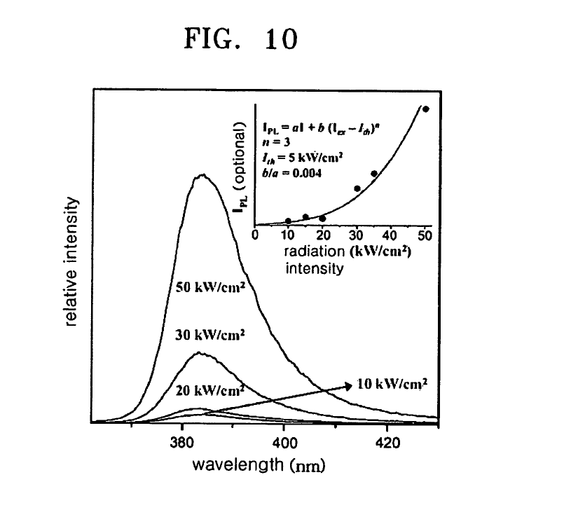

FIG. 10 is power-dependent PL spectra of the ZnO nanowall array. Referring to FIG. 10, the ZnO nanowall array of the present invention exhibited the UV laser threshold of 5 kW/cm² which was about 90% lower than the lowest threshold (40 kW/cm²) obtained in currently available nanorod arrays.

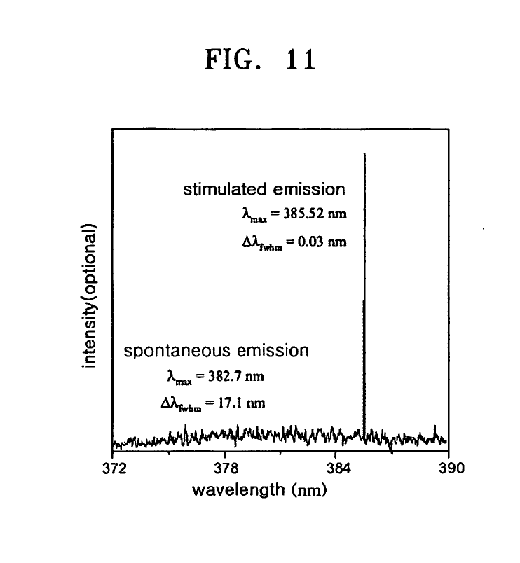

FIG. 11 is a PL spectrum of the ZnO nanowalls at 15 kW/cm². Referring to FIG. 11, very strong second-stimulated emission was observed at 15 kW/cm² by an EHP process. The second-stimulated emission had a linewidth of 0.03 nm which was 600 times smaller than a spontaneous emission linewidth and 10 times smaller than the emission linewidth (0.3 nm) of a common high-quality ZnO nanorod array at 100 kW/cm². The cavity length of the ZnO nanowall array calculated using the emission linewidth was 1,011 μm which was maximal among the cavity lengths of currently available ZnO structures.

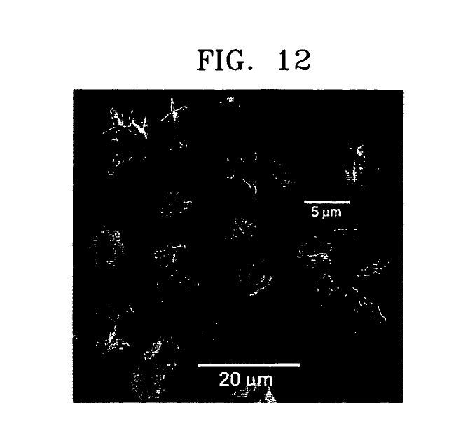

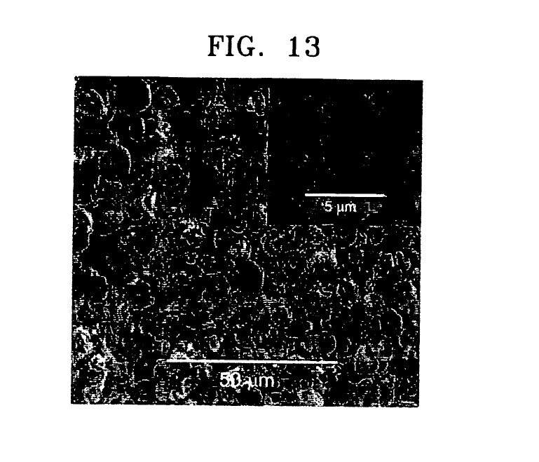

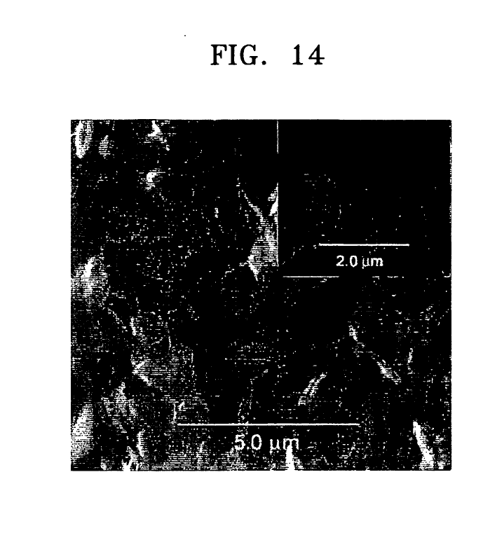

ZnO structures of various shapes were observed during formation of the ZnO nanowall array. FIG. 12 shows a flower-like ZnO array formed on a Si-wafer by diluting ZnO nanoparticles more than about 20 times followed by dip-coating. FIG. 13 shows pineapple-like, bulk ZnO particles grown from a remaining solution after formation of the ZnO nanowall array. These pineapple-like, bulk ZnO particles also had wide [0001] planes, like the ZnO nanowalls. FIG. 14 is an SEM image of hexagonal plate-like ZnO nanoparticles grown by reaction of ZnO nanoparticles with a nutrient solution without dip-coating on a Si-wafer. This illustrates that in the case of using the synthesis method of Example 5, the crystal growth rate of ZnO is in the order of V_{[01-10]}>>V_{[0001]}≈V_{[000-1]}. That is, it can be seen that a crystal growth of ZnO nanoparticles in the c-axis direction is controlled by citrate ions, thereby inducing a hexagonal flower-like structure of FIG. 12 or a hexagonal plate-like structure of FIG. 14, unlike a common hexagonal pillar-like structure.

What is claimed is:

1. A method of forming a ZnO nanorod array, which comprises:
coating on a substrate ZnO nanoparticles serving both as a buffer layer and a seed layer; and
growing the ZnO nanoparticles into crystals in a nutrient solution containing hexamethylenetetramine and Zn nitrate, Zn acetate, or a derivative thereof.

2. A method of forming a ZnO nanowall array, which comprises:
coating on a substrate ZnO nanoparticles serving both as a buffer layer and a seed layer; and
growing the ZnO nanoparticles into crystals in a nutrient solution containing Zn acetate or its derivative and sodium citrate.

3. The method of claim 1, wherein the substrate is made of Si, sapphire (Al₂O₃), GaN, ScAlMgO₄, or LiNbO₃.

4. The method of claim 1, wherein the operation of growing the ZnO nanoparticles in the nutrient solution is performed at 30 to 400 □, and the volume ratio of Zn nitrate, Zn acetate, or a derivative thereof, to hexamethylenetetramine in the nutrient solution is 10:1 to 1:10.

5. The method of claim 2, wherein the operating of growing the ZnO nanoparticles in the nutrient solution is performed at 30 to 400 □, and the volume ratio of Zn acetate or its derivative to sodium citrate in the nutrient solution is 10:1 to 1:10.

6. A ZnO nanorod array formed by the method of claim 1.

7. A ZnO nanowall array formed by the method of claim 2.
